(19) United States
(12) Patent Application Publication
(10) Pub. No.: US 2011/0082714 A1
(43) Pub. Date: Apr. 7, 2011

(54) Dynamic Reallocation of Seats in Rail Travel Using RFID Technology

(75) Inventor: Hemant Gaikwad, Kondhwa (IN)

(73) Assignee: INTERNATIONAL BUSINESS MACHINES CORPORATION, Armonk, NY (US)

(21) Appl. No.: 12/573,105

(22) Filed: Oct. 3, 2009

(51) Int. Cl. G06Q 10/00; G06K 19/00; G06K 7/10

(52) U.S. Cl. 705/5

(57) ABSTRACT

Tickets with RFID devices are issued to train passengers. Once the passengers board the train, the number and location of vacant seats is determined based on signals from the RFID devices detected by RFID readers configured within the passenger compartments of the train. Seating information is displayed on screens fitted in each compartment. This is done at or after the train reaches every major station, facilitating wait-listed passengers to occupy any vacant seats that become available.

### BACKGROUND

1. Field of the Invention

The present invention relates to method and systems for organizing mass transit travel logics, and more specifically, to systems and methods of reallocating seats on a carrier.

2. Description of Related Art

For a rail journey the passengers reserve their tickets in advance. Some passengers may receive confirmed tickets for their travel, while other passengers are put on a waiting list and get tickets with a waiting list number. The waiting list number is decremented each time there is a seat cancellation by another passenger who holds a reservation made at an earlier time. Thus, the waiting list keeps updating until the last minute of the departure time for the rail journey. Thereafter, passengers who have confirmed reservation tickets board the train to occupy their reserved seats. However, passengers who are still in the waiting list still have the possibility of being seated if there are any vacant seats left. Sometimes there are a few seats that were reserved but are still not occupied because the passengers were no-shows without cancellation of their reservations.

The in-house rail staff has to go through all the rail compartments and check every ticket thereafter to check for intruders and also for seats that are vacant in spite of being reserved from that boarding station. Hence, at a particular station to find the total number of seat occupancy, the in-house rail staff often has to spend about 30-40 minutes confirming that each seat is occupied/unoccupied. This is repeated at every major station along the route of the rail journey. After the rail staff confirms the status of each seat, the number of reserved but unoccupied seats can be calculated and passengers who are in the waiting list may be offered these seats based on their spot in the waiting list.

Even if seats are available it can be very difficult to track the waiting list passengers inside the train. Sometimes one or more passengers on the waiting list decide not to board the train since they do not hold reserved seats at the time of departure from the station. Another difficulty occurs when passengers get off the train before the destination station listed on their ticket through which their seat was reserved. When this happens the seats simply remain vacant for the rest of the journey even though they are available for seating other passengers.

Due to the above mentioned drawbacks conventional systems of seat allocation are ineffective in performing systematic allocation, de-allocation and reallocation of railway seats. The present inventor recognized that what is needed is a new system for dynamically reallocating the rail seats to the passengers on the waiting list.

### SUMMARY

Various embodiments of this disclosure overcome the drawbacks of conventional systems and make more effective utilization of the available seating resources in a railway public transport system used for long distance journeys. The system leverages Radio-frequency IDentification (RFID) technology in order to achieve efficiency gains.

Embodiments disclosed herein provide systems, methods and computer products for allocating seats on a railway train by providing RFID readers in each of the train's passenger cars. RFID railway tickets are sold for passage on the train. The RFID tickets are configured to be read by the RFID readers located in the train's passenger compartments. The system finalizes a seating arrangement for the railway train before the railway train reaches a train station or other seating evaluation point. As the passengers get on and off the train at the train station the RFID readers detect any available seats. The system then displays this information about available vacant seats on display screens located in the passenger compartments. In some embodiments information about seating availability may be directly communicated to wait-listed ticket holders via cellular telephone calls, text messages, or pager messages.

### BRIEF DESCRIPTION OF THE DRAWINGS

The accompanying drawings, which are incorporated in and constitute part of the specification, illustrate various embodiments of the invention. Together with the Detailed Description, the drawings serve to explain the principles of the invention. In the drawings:

FIG. 1A depicts an overview of information handling components in a system configured to reallocate seats for passengers on a railway train 101;

FIG. 1B is a top view of a rail car according to various embodiments disclosed herein;

FIG. 2 is a flowchart of a method for practicing various embodiments disclosed herein;

FIG. 3 depicts various components of a system for dynamically reallocating railway train seats using RFID technology according to various embodiments disclosed herein; and

FIG. 4 depicts a computer system suitable for implementing and practicing the various embodiments.

### DETAILED DESCRIPTION

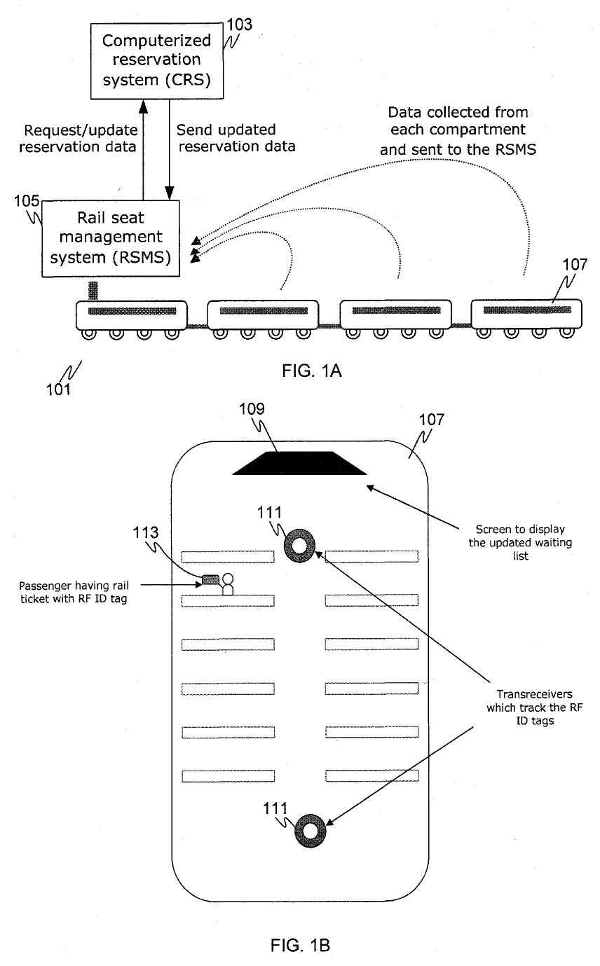

FIG. 1A depicts an overview of information handling components in the system as it is used by passengers on a railway train 101. The new system is helpful in doing a dynamic and systematic seat allocation using RFID tags/readers or other like sensors to track available seats for more effective seat allocation/reallocation. Passenger reservation and ticket information is stored in the Computerized Reservation System (CRS) 103. The CRS is not generally located on the train 101, but rather, is typically located in a central location (e.g., a reservation center or data center). In some implementations the CRS 103 may include components distributed in different locations and interconnected by communications links (e.g., via the Internet, telephone, radio transmissions, satellite communication links, or the like).

A Rail Seat Management System (RSMS) 105 is included on the train 101. The RSMS 105 is configured to collect data from RFID readers in each car to ascertain the number of passengers sitting in each car. For example, data of the passengers located in railcar 107 is collected by one or more RFID readers positioned within railcar 107, and then transmitted from railcar 107 to the RSMS 105. The RSMS 105 also communicates with CRS 103 to determine the number of seats sold on any particular leg of the train's route. This allows the system to track all passengers who have boarded train 101 at a particular stop in a very short time interval, hence saving the time and efforts of in-house rail staff. In this way the system not only dynamically allocates the rail seats in an effective manner, but also ensures that there aren't any intruders, since typically most of the seats would be allocated at any given time instance. The CRS 103 and RSMS 105 implement the identification, detection, updating and mapping of RFID tickets 113 with the dynamically allocated seat numbers. The system uses one or more display screens 109 to communicate seating allocation information. The system can also be adapted to other using other types of communication in addition to, or instead of, the display screens 109. For example, seating information can be sent using personalized messages directly to passengers, for example, to passengers holding wait-listed tickets. The messages may be sent by any of several know means of communications such as messages to a passenger's cell phone containing an updated seating arrangement.

FIG. 1B is a top view of the rail car 107 according to various embodiments of the invention. The number and location of the vacant seats is updated accordingly and screens 109 fitted in each train compartment or passenger car display the updated waiting list/seat arrangement in real time. This is done at or after the train reaches every major station, facilitating passengers to occupy any vacant seats that may be available. Each rail car 107 also has one or more RFID readers 111 configured to detect passengers with an RFID railway ticket 113 located within the car. (RFID readers 111 may sometimes be known as RFID transceivers, RFID detectors, RFID tag sensors, or other such names.) In some embodiments there may be an RFID reader 111 in each seat. In other embodiments, the RFID readers 111 are configured within the railcar so as to be able to detect where the passengers holding the RFID tickets 113 are seated. This may be done by triangulating the signals, detecting the signal strength, positioning multiple RFID readers throughout the car, or in other like manners. In yet other embodiments the RFID readers 111 may not be able to detect which seats are occupied/unoccupied, but instead may be able to detect how many RFID tickets 113 are within each rail car. In this way, the system can determine how many unoccupied seats are in each car, even though the system would not necessarily know which particular seats are unoccupied.

Depending upon the implementation, the system can be extended to other scenarios like airlines, ship travel, passenger buses, or the like. The various embodiments leverage the RFID technology in providing a system that is capable of allocating, de-allocating and reallocating passenger seats dynamically during a rail journey. All of this can be done in real time, an advantage over conventional seating allocated methods and procedures.

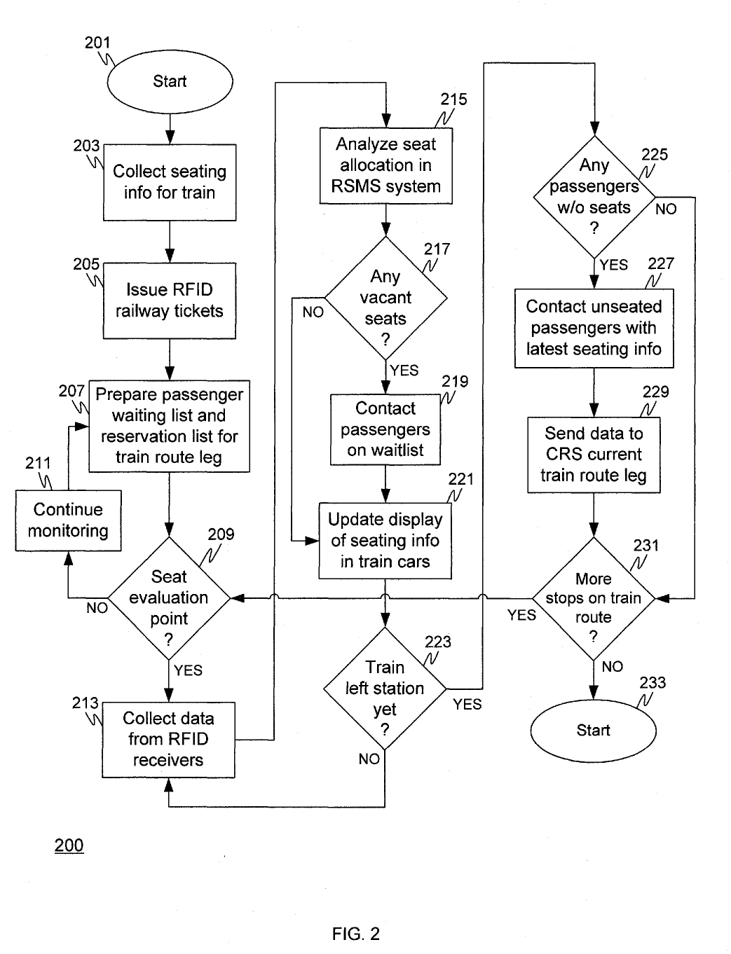

FIG. 2 is a flowchart of a method for practicing various embodiments of the invention. The method begins in 201 and proceeds to 203 to collect seating information for the train that is to be used along the route. Before a train goes into service on a railway route it is assembled from various types and configurations of railway cars. Each train includes a combination of passenger cars, sleeper cars, dining cars, parlor cars, sometimes an observation car, or other types of railway cars. The configuration of each type of railway car may change over time as new models are built and put into service. In order to determine the number of unoccupied seats it is important to know how many seats there are on the train, and in some implementations, within each car of the train. Therefore, in block 203 the information of the cars making up the train is collected for use in tracking the seating occupancy. Upon completing block 203 the method proceeds to 205.

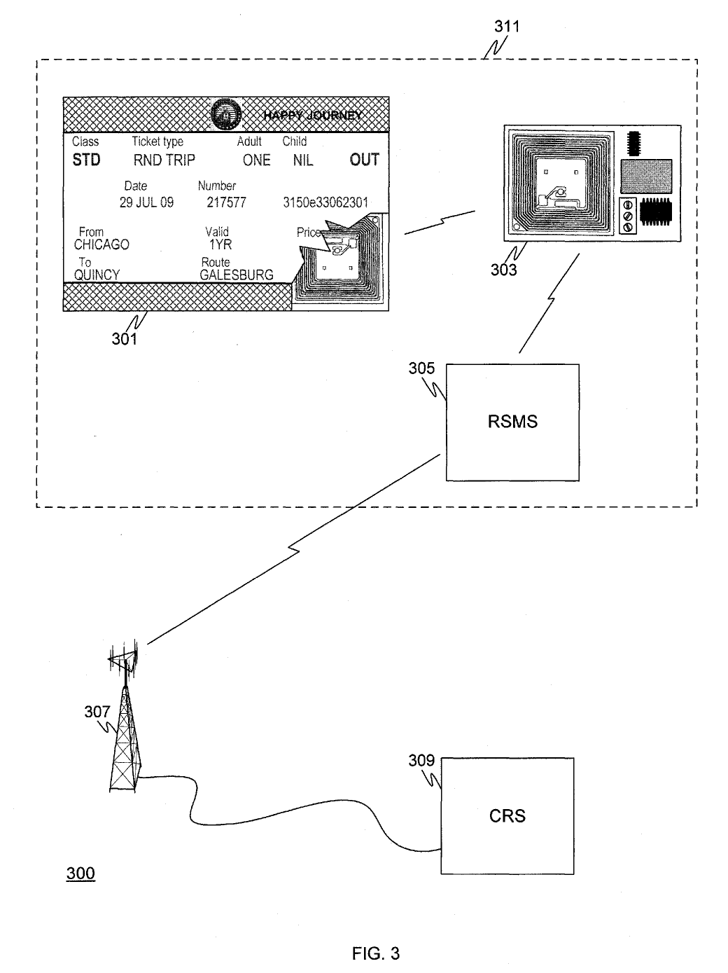

In block 205 passengers are issued railways tickets having RFID tags (e.g., an RFID antenna and associated electronics). In some embodiments the RFID tag may be embedded in the ticket, printed on the ticket, or otherwise incorporated as part of the railway ticket. Ticket 301 of FIG. 3 is an example of a ticket with an embedded RFID tag which is shown in the cutaway portion of the figure. In other embodiments the RFID tag may be affixed to the ticket, although not necessarily embedded. In yet other embodiments the RFID tag may be reusable, for example, in a plastic case that attaches to the ticket or is configured to hold the ticket. This configuration is especially useful for frequent travelers, and allows the railway company to provide a higher quality, longer range RFID tag (e.g., an active RFID tag) than is feasible in using disposable RFID tags. In various embodiments passenger travel information may be stored on passive RFID tags. Typically, the information on the RFID tickets includes the passenger identification and the seat number for confirmed tickets, or the waitlist number if the tickets are unconfirmed tickets. The tickets may also have other required information related to the travel and passenger. Once the RFID tickets have been sold to passengers in 205 the method proceeds to 207.

In block 207 of FIG. 2 the passenger waiting list and the reservation list for the train route leg are each prepared. Both lists may be prepared couple of hours or so before the start of the rail journey, but generally continue to be updated until the train pulls out of the station, or even after the train pulls out of the station, if necessary. For example, if a previously undetected passenger is detected on a moving train (e.g., a waitlist passenger who boarded, hoping to find a seat), the RSMS system on the train may communicate wirelessly with the central CRS system to update the passenger list while the train is moving. The passenger waiting list and the reservation list may be prepared by the CRS system which has access to run time cancellations (cancellations at the last minute, of which only the CRS is aware), non-boarding ticket holders at the specified stations (drop outs without cancellation), updates of the waitlist (waitlists are updated after every cancellation). Much of this information may only be available at CRS, since passengers communicate with the central CRS location to make and/or cancel reservations. Information provided by the RSMS system (e.g., the dynamic information of the passengers and seat allocation) may also be used in updating the passenger waiting list. Upon completing the passenger waiting list and the final passenger reservation list in 207 the method proceeds to 209.

In block 209 the system determines whether a railway seat occupancy evaluation point has been reached. A railway seat occupancy evaluation point is a point along the train's route, or a point in time, where the system collects RFID data to determine where the empty seats, if any, are located on the train, updates and displays this information, and may contact waitlisted ticket holders or passengers onboard the train who cannot find an empty seat. In various embodiments this is done at each train stop along the way, while in other embodiments it is performed only at major stops or at certain predetermined railway stops. In some embodiments the monitoring of RFID data and various other activities may be performed as ongoing processes throughout the trip. In yet other embodiments, predetermined stops may be designated as seat occupancy evaluation points, and the system may also perform the RFID monitoring/display/contact activities at given time intervals (e.g., every 5 minutes, 10 minutes, 20 minutes, etc.) along the way. If it is determined in 209 that a railway seat occupancy evaluation point has not yet been reached the method proceeds from 209 along the “NO” path to 211 to continue monitoring. The method then proceeds to 207 to update the list of reservations to reflect any passengers who may have purchased tickets recently. Back in 209, if it is determined that a railway seat occupancy evaluation point has been reached the method proceeds from 209 along the “YES” path to 213.

In block 213 RFID readers (e.g., RFID readers 111 of FIG. 1B) fitted in each train compartment collect data and monitor the passengers' RFID tags for that particular compartment. In some embodiments the RFID readers are positioned such that they can detect where each passenger is seating and whether or not a particular seat is empty. In other embodiments the RFID receivers may be positioned so that the number of passengers per train car (or per compartment) can be detected, without necessarily knowing where the empty seats, if any, are located within the car (or compartment). The detection of RFID tickets may be done either on an on-going basis during the train's route with the results being updated as passenger changes are detected as the passengers are boarding and deboarding as the train sits at a station. In some implementations the detection of RFID tickets may begin after the train pulls away from a source station, and/or may be performed either before or after every major station, or any combination of these points. The tag monitoring process collects information of both the passengers with confirmed tickets and passengers with wait-listed tickets. Upon completing 213 the method proceeds to 215.

In block 215 the data collected for a particular compartment (or car, or an individual seat) is collated and sent to the RSMS (e.g., RSMS 105 of FIG. 1A) for analysis and tracking of seating allocation information. Block 215 may also entail communicating the updated railway seating information back and forth between the centrally located CRS system and the RSMS on the train. The RSMS system now sends the vacant seats information along with the seat allocations to the respective compartments. The RSMS is a centralized seat management system located on the railway train itself. In block 215, once the ticket data has been collected by the RSMS, the system analyzes the data sent by the readers in each compartment, or near each seat, or other location. Typically, the analysis includes a compilation of the number of passengers who boarded the compartment, and verification that the passengers boarded the correct compartment. It sometimes happens that a passenger may board the wrong compartment. In some implementations the system can request that the passenger move in to the correct compartment. The request can be made using the display system, or the system may use other means to communicate with individual passengers such as a text message or page, a wireless phone call, or the like.

The RSMS also analyzes the data to determine the number of passengers holding wait-listed tickets who boarded the rail. In some implementations the system can identify which compartment the wait-listed passenger boarded. In accordance with various embodiments this information is used to display an updated seating arrangement in context to the wait-listed passenger's location. For example, if it is determined that passenger “X” holding a wait-listed ticket boarded compartment “2,” and the seat arrangement update allocates passenger X a seat in compartment “6,” then that information can be displayed on the screen in compartment “2.” The ability to display information based on the location of the passenger helps to ensure that all passengers find a seat on the train.

In block 215 the RSMS verifies the vacant seats based on the final list prepared before the start of the journey, with additional information from the updated seat allocation and the information of passengers who did not board the train at the station they were suppose to board. (Some passengers may fail to board without canceling of their tickets.) The RSMS also uses information of passengers who deboard the train before their actual destination station for some reason, thus vacating their seat. As the RSMS system tracks and analyzes the seating availability, it may send the analysis report to the CRS. Once the seating allocation has been analyzed in Mock 215 the method proceeds to 217.

If it is determined in block 217 that there are not any vacant seats the method proceeds from 217 along the “NO” path to 221 to update the displays in the train cars with seating info. The seating info displayed in each train car may be specific to that train car, and may also include information of the other cars in the train as well. For example, a display may provide the following type of information: “Train car 8: No vacancies. Nearest seat vacancies 3 cars ahead in car 5 (3 vacant seats).” Back in block 217, if it is determined that there are one or more vacant seats then the method proceeds from 217 along the “YES” path to 219. Block 219 is similar to block 221 in that both activities are intended to convey information to passengers about seating availability on the train. Block 221 uses the display screens positioned within each car of the train. Block 219 communicates in a more directed manner, using an available communication link directly to the passenger such as a text message or page, or a wireless phone call to the passenger. Using direct communication with the passenger allows the system to exert more control over the management of the available vacant seats. For example, there may be two parties of travelers looking for seats on a train—a party of two passengers and a different party of three. In this example, the train may have two locations with adjacent empty seats—a pair of empty seats together and in a different train car a block of three empty seats together. If no direction is given from the system, the group of two may find the block of three empty seats before the group of three, thus causing problems in the seating of the passengers. However, if the system intervenes and directly contacts both groups (e.g., via text message) and steers them to the appropriate block of seats for their party's size, the system will generally be able to efficiently allocate the blocks of empty seats to the appropriate sized blocks of passengers, thus more efficiently utilizing the available seating resources. Even if direct contact is made in 219 to selected passengers, the system still displays general information about seating availability for the benefit of other passengers and ticket holders. Therefore, upon completing 219 the method proceeds to 221 to update the one or more display screens located in each train car.

Once the display screens located in each train car have been updated in 221 the method proceeds to 223. If it is determined in block 223 that the train is still sitting at the station with passengers boarding/deboarding then the method loops back around from 223 along the “NO” path to 213 to read the RFID receivers and continue updating the seating information. However, if the train has pulled away from the station then no more passengers can get on or off the train. The system then attempts to guide unseated passengers, if any, to available empty seats on the train. To do this the method proceeds from block 223 along the “YES” path to 225.

Block 225 determines whether there are any passengers on the train without seats once the train begins moving. If there are no unseated passengers the method proceeds along the “NO” branch to block 231. However, if it is determined in block 225 that there are unseated passengers still trying to find a place to sit then the method proceeds from 225 along the “YES” branch to 227. In block 227 the system attempts to contact the unseated passengers either by direct link (e.g., text message, page or cell phone) or by directing an attendant to the unseated passengers. This may be done by communicating the location of the unseated passengers to the train conductor responsible for the car in which the passengers are located. In some embodiments the train conductors have handheld instruments that communicate with the RSMS and display seating information. The seating information displayed to the conductor may be more detailed and comprehensive than that displayed publicly on the display screens configured within each train car.

Once the unseated passengers have been attended to in block 227 the method proceeds to 229 to update the CRS with the latest data for the present leg of the train route. Typically this is done by wireless communication between the RSMS and the CRS, as depicted in FIG. 1A. The method then proceeds to 231. If it is determined in block 231 that there are to be more stops (or more evaluation points) on the train route the method proceeds from 231 along the “YES” path to 209 to monitor for a seating evaluation point at which time the process of evaluating and displaying available seating begin again. However, if it is determined in block 231 that there are no more stops on the train's route (e.g., the train is traveling down the last leg of its route), then the method proceeds from 231 along the “NO” branch to 233 where it ends.

FIG. 3 depicts various components of a system for dynamically reallocating railway train seats using RFID technology. The components located within dotted line 311 are components typically located on the train, while the CRS 309 is typically located at one central location, e.g., at the railway company's headquarters, a call center, or other railway facility involved in handing the logistics of ticket sales, scheduling and/or management functions. One component of the system is the ticket 301 itself. In various embodiments, railway ticket 301 has an RFID tag embedded within it, or otherwise attached to it. RFID tags are small devices that respond to an RF interrogation signal with a RF response at a predetermined frequency. The response may contain data in addition to identification information. RFID Tags may be implemented to either provide a passive response or an active response. Various embodiments of railway ticket 301 configured with passive RFID technology use the received energy from the interrogation signal to generate a response. Some embodiments may use active RFID tags which tend to have a considerably longer range than passive tags because they generate and transmit a response signal using power from a power supply of the active RFID tag (e.g., a battery). Active tags may be queried up to 200 feet or more, depending upon the dimensions of the coil antenna and the quality of components used in the device.

The RFID tag in the railway ticket 301 is detected by a RFID reader device 303 which may be used to implement the various embodiments. The RFID reader device 303 typically includes circuitry or logic capable of sending out an interrogation signal and receiving a response back, as well as circuitry or logic for responding to the interrogation signal of an RFID tag. Upon receiving the interrogation signal, the other RFID tags in the vicinity return a response to the reader, either actively or passively, as described above. The RFID tags in the ticket 301 and the RFID readers 303 located within the railroad passenger cars may be any of several types of RFID tags and readers, including, for example, the RFID tags and readers described in U.S. Patent Publication 2005/0049760 to Narayanaswami et al., and in U.S. Pat. No. 6,802,659 to Cremon et al., the contents of both documents being hereby incorporated by reference in their respective entireties. Embodiments of the RFID reader device 303 are often configured to include a silicon microprocessor and a metal coil surrounded by an encapsulating material of glass or polymer material. The metal coil, which serves as an antenna, is typically made of copper or aluminum traces which are wound into a circular pattern on the tag. The size of the coil antenna determines the sensitivity of the RFID reader device 303, and the distance that signals can be transmitted. RFID coil antennas often operate at 13.56 MHz but can be designed to be operated at a wide range of other frequencies. Other RFID circuitry designs and configurations may be used in the various embodiments, as known by those of ordinary skill in the art.

The RFID tag in the ticket 301 may be an inductively coupled RFID tag which uses energy from the magnetic field generated by the RFID reader. The coil antenna of the RFID tag translates the magnetic energy into an electrical signal which is communicated to the logic of RFID reader device 303. To respond to the interrogation signal the RFID reader device 303, the RFID tag modulates the magnetic field, transmitting identification data back to the reader which sent the interrogation signal. The RFID tag may be implemented as a capacitively coupled RFID as the detection and transmission ranges increase for these devices. Capacitively coupled RFID tend to cost less than inductively coupled RFID tags. Capacitively coupled RFID tags do not have a coil antenna, instead using silicon circuitry to perform the function of the coil antenna. A capacitively coupled RFID tag typically includes a silicon microprocessor and conductive carbon ink which serves as the tag's antenna applied to a paper substrate. The conductive carbon ink antenna may be applied to the paper substrate through conventional printing means. The paper substrate, in turn, often has an adhesive backing to allow bonding to ticket. The RFID tag in railway ticket 301 may include a programmable memory configured to be modified or updated by an RFID writer contained at the ticket booth or other point of sale for the railway ticket. The RFID writer can write to the programmable memory or other writable logic of the RFID tag to change data stored on it, for example, to indicate the train route, reservation priority, and other information associated with the railway ticket.

The RFID reader devices 303 located throughout the train, e.g. in each car and/or compartment, are configured to communicate with the RSMS on the train. The systems are typically configured to communicate wirelessly, but in some implementations may use a wired communication link. The RSMS 305 includes a computer, or processor and memories or other logic, capable of manipulating and storing passenger seating data received from the RFID reader devices 303 spread throughout the train. The RSMS 305 also includes a communication unit configured to wirelessly communicate with the central CRS system 309. This wireless communication may be carried out using the train's business band wireless channels, cellular telephone links, or any other wireless system capable of conveying data communications. The CRS 309, like the RSMS 305, is configured with one or more computers (or processors and memories or other logic) capable of recording, manipulating and storing passenger seating data. The CRS 309 may be configured with more extensive computing equipment than RSMS 305 since CRS 309 communicates with a great number of passenger trains throughout the railway system and each RSMS 305 is specific to the train on which it is located.

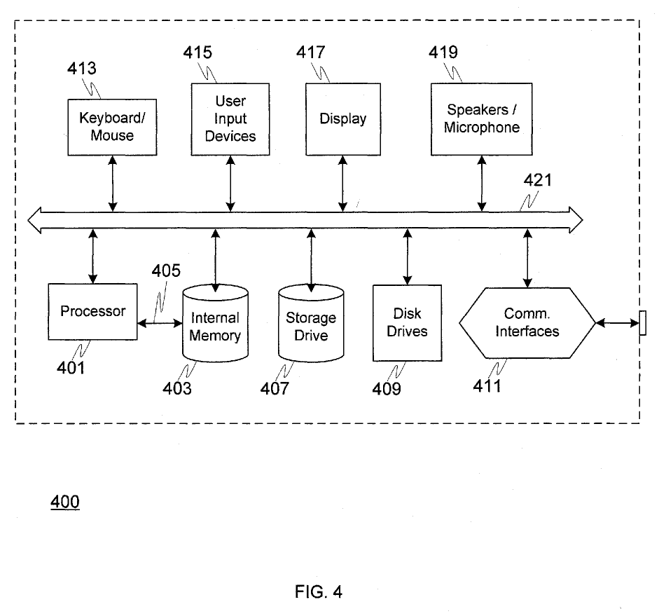

FIG. 4 depicts computer system 400 suitable for implementing and practicing the various embodiments. The computer system 400 may be configured in the form of a desktop computer, a laptop computer, a mainframe computer, or any other arrangement capable of being programmed or configured to carry out instructions. The computer system 400 may be located and interconnected in one location, or may be distributed in various locations and interconnected via communication links such as a local or wide area network (LAN or WAN), via the Internet, via the public switched telephone network (PSTN), or other such communication links. Other devices may also be suitable for implementing or practicing the embodiments, or a portion of the embodiments. Such devices include personal digital assistants (PDA), wireless handsets (e.g., a cellular telephone or pager), and other such consumer electronic devices preferably capable of being programmed to carry out instructions or routines.

Computer system 400 includes a processor 401 which may be embodied as a microprocessor, two or more parallel processors, central processing unit (CPU) or other such control logic or circuitry. The processor 401 is configured to access an internal memory 403, generally via a bus such as the system bus 421. The internal memory 403 may include one or more of random access memory (RAM), read-only memory (ROM), cache memory, or a combination of these or other like types of circuitry configured to store information in a retrievable format. In some implementations the internal memory 403 may be configured as part of the processor 401, or alternatively, may be configured separate from it but within the same packaging. The processor 401 may be able to access internal memory 403 via a different bus or control lines (e.g., local bus 405) than is used to access the other components of computer system 400.

The computer system 400 also includes, or has access to, one or more storage drives 407 (or other types of storage memory) and floppy disk drives 409. Storage drives 407 and the floppy disks for floppy disk drives 409 are examples of machine readable (also called computer readable) mediums suitable for storing the final or interim results of the various embodiments. The floppy disk drives 409 may include a combination of several disc drives of various formats that can read and/or write to removable storage media (e.g., CD-R, CD-RW, DVD, DVD-R, floppy disk, or the like). The computer system 400 may either include the storage drives 407 and floppy disk drives 409 as part of its architecture (e.g., within the same cabinet or enclosure and/or using the same power supply), as connected peripherals, or may access the storage drives 407 and floppy disk drives 409 over a network, or a combination of these. The storage drive 407 is often a hard disk drive configured for the storage and retrieval of data, computer programs or other information. The storage drive 407 need not necessarily be contained within the computer system 400. For example, in some embodiments the storage drive 407 may be server storage space within a network that is accessible to the computer system 400 for the storage and retrieval of data, computer programs or other information. In some instances the computer system 400 may use storage space at a server storage farm, or like type of storage facility, that is accessible by the Internet or other communications lines. The storage drive 407 is often used to store the software, instructions and programs executed by the computer system 400, including for example, all or parts of the computer application program for carrying out activities of the various embodiments of the invention.

The computer system 400 may include communication interfaces 411 configured to be communicatively connected to the Internet, a local area network (LAN), a wide area network (WAN), or connect with other devices using protocols such as the Universal Serial Bus (USB), the High Performance Serial Bus IEEE-1394 and/or the high speed serial port (RS-232). The computers system 400 may be connected to the Internet via a wireless router or a wired router or other such access node (not show). The components of computer system 400 may be interconnected by a bus 421 and/or may include expansion slots conforming to any of various industry standards such as PCI (Peripheral Component Interconnect), ISA (Industry Standard Architecture), or EISA (enhanced ISA).

Typically, the computer system 400 includes one or more user input/output devices such as a keyboard and/or mouse 413, or other means of controlling the cursor represented by the user input devices 415 (e.g., touchscreen, touchpad, joystick, trackball, etc.). The communication interfaces 411, keyboard and mouse 413 and user input devices 415 may be used in various combinations, or separately, as means for receiving information and other inputs to be used in carrying out various programs and calculations. A display 417 is also generally included as part of the computer system 400. The display may be any of several types of displays, including a liquid crystal display (LCD), a cathode ray tube (CRT) monitor, a thin film transistor (TFT) array, or other type of display suitable for displaying information for the user. The display 417 may include one or more light emitting diode (LED) indicator lights, or other such display devices. In addition, most computer systems 400 also include, or are connected to, one or more speakers and microphones 419 for audio output and input. Speech recognition software may be used in conjunction with the microphones 419 to receive and interpret user speech commands.

Various activities may be included or excluded as described above, or performed in a different order, while still remaining within the scope of at least one of the various embodiments. For example, block 203 describes the collection of seating information for the train. Occasionally, a train will be reconfigured during at some point in the route, either with train cars being added to the train or split off from the train and added to another train. In such instances block 203 is performed again for the newly reconfigured train so that the RSMS of the train has the current train car and seating configuration for the train. Another activity that can take place in a different order than depicted in the figures is block 219 which entails contacting the waitlisted passengers with information about vacant seats on the train. In some embodiments the waitlisted passengers can be contacted in block 219 with information about vacant seats as well as with other relevant information about the seating situation, e.g., that no vacant seats exist, the number of other waitlisted passengers ahead of them on the waitlist, a prediction of the number of vacant seats expected at that stop, or other such information. Other steps or activities of the methods disclosed herein may be omitted, repeated, or performed in a different manner while remaining within the intended scope of the invention.

The invention may be implemented with any sort of processing units, processors and controllers (e.g., processor 401 of FIG. 4) capable of performing the stated functions and activities. For example, the processor 401 may be embodied as a microprocessor, microcontroller, DSP, RISC processor, two or more parallel processors, or any other type of processing unit that one of ordinary skill would recognize as being capable of performing or controlling the functions and activities described herein. A processing unit in accordance with at least one of the various embodiments can operate computer software programs stored (embodied) on computer-readable medium such those compatible with the disk drives 409, the storage drive 407 or any other type of hard disk drive, CD, flash memory, ram, or other computer readable medium as recognized by those of ordinary skill in the art.

The computer software programs can aid or perform the steps and activities described above. For example computer programs in accordance with at least one of the various embodiments may include: source code for operating a plurality of RFID readers on passenger cars of a railway train; source code for creating and selling RFID tickets for passage on the railway train; source code for finalizing a seating arrangement for the railway train before it reaches a train station; source code for detecting available seats on the railway train by sensing the RFID tickets in each of the train's passenger cars; and source code for communicating information about the available seats to wait-listed ticket holders. There are many further source codes that may be written to perform the various steps, activities and procedures disclosed above that are intended to lie within the scope of the various embodiments. Various activities may be included or excluded as described above, or performed in a different order, with the rest of the activities still remaining within the scope of at least one exemplary embodiment.

The description of the various embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the intended scope of the present invention.

What is claimed is:

1. A method of allocating seats on a railway train, the method comprising:
providing a plurality of RFID readers on passenger cars of the railway train, at least one of the plurality of RFID readers being located in each of said passenger cars;
selling RFID tickets for passage on the railway train, wherein said RFID tickets are configured to be read by the plurality of REID readers;
finalizing a seating arrangement for the railway train before the railway train reaches a train station;
allowing passengers to get on or off the railway train at the train station;
detecting available seats on the railway train by sensing the RFID tickets in each of the passenger cars of the railway train; and
communicating information about the available seats to wait-listed ticket holders.

2. The method of claim 1, wherein said RFID tickets are configured with passive RFID technology.

3. The method of claim 1, wherein the communicating of the information further comprises:
displaying the information about the available seats on display screens located in each of the passenger cars of the railway train.

4. The method of claim 1, wherein the communicating of the information further comprises:
contacting one of said wait-listed ticket holders via one of a cellular telephone call, a text message, or a pager message.

5. The method of claim 1, further comprising:
collecting the information about the available seats at a rail seat management system (RSMS) located on the railway train; and
sending said information to a computerized reservation system (CRS) not located on the railway train.

6. The method of claim 5, wherein said railway train is one of a plurality of passenger trains in communication with said CRS.

7. The method of claim 6, wherein said CRS receives passenger ticket purchase information used in the finalizing of the seating arrangement.

8. The method of claim 1, further comprising:
detecting a passenger holding a reserved seat ticket who is sitting in a wrong seat; and
communicating with said passenger holding the reserved seat ticket about the wrong seat.

9. A software product comprising a program of instructions stored on a machine readable device for allocating seats on a railway train, wherein the program of instructions upon being executed on a computer causes the computer to perform activities comprising:
providing a plurality of RFID readers on passenger cars of the railway train, at least one of the plurality of RFID readers being located in each of said passenger cars;
selling RFID tickets for passage on the railway train, wherein said RFID tickets are configured to be read by the plurality of RFID readers;
finalizing a seating arrangement for the railway train before the railway train reaches a train station;
allowing passengers to get on or off the railway train at the train station;
detecting available seats on the railway train by sensing the RFID tickets in each of the passenger cars of the railway train; and
communicating information about the available seats to wait-listed ticket holders.

10. The software product of claim 9, wherein said RFID tickets are configured with passive RFID technology.

11. The software product of claim 9, wherein the communicating of the information further comprises:
displaying the information about the available seats on display screens located in each of the passenger cars of the railway train.

12. The software product of claim 9, wherein the communicating of the information further comprises:
contacting one of said wait-listed ticket holders via one of a cellular telephone call, a text message, or a pager message.

13. The software product of claim 9, further comprising:
collecting the information about the available seats at a rail seat management system (RSMS) located on the railway train; and
sending said information to a computerized reservation system (CRS) not located on the railway train.

14. The software product of claim 13, wherein said railway train is one of a plurality of passenger trains in communication with said CRS.

15. The software product of claim 14, wherein said CRS receives passenger ticket purchase information used in the finalizing of the seating arrangement.

16. The software product of claim 9, further comprising:
detecting a passenger holding a reserved seat ticket who is sitting in a wrong seat; and
communicating with said passenger holding the reserved seat ticket about the wrong seat.

17. A system configured to allocate seats on a railway train, the system comprising:
a plurality of RFID readers positioned on passenger cars of the railway train, at least one of the plurality of REID readers being located in each of said passenger cars;
RFID tickets for passage on the railway train, wherein said RFID tickets are configured to be read by the plurality of RFID readers;
a processor configured to execute software instructions for finalizing a seating arrangement for the railway train before the railway train reaches a train station, wherein after the finalizing of said seating arrangement passengers get on or off the railway train at the train station; and
communication means for communicating information about available seats to wait-listed ticket holders;
wherein said plurality of RFID readers are configured to detect available seats on the railway train by sensing the RFID tickets in each of the passenger cars of the railway train.

18. The system of claim 17, wherein the communication means further comprises:
a display device configured to display the information about the available seats on display screens located in each of the passenger cars of the railway train.

19. The system of claim 17, wherein the communication means is a first communication means, the system further comprising:
second communication means for contacting one of said wait-listed ticket holders via one of a cellular telephone call, a text message, or a pager message.
